(19) United States
(12) Patent Application Publication
(10) Pub. No.: US 2025/0331030 A1
(43) Pub. Date: Oct. 23, 2025

(54) SYSTEM INFORMATION REQUEST

(71) Applicant: Samsung Electronics Co., Ltd., Suwon-si (KR)

(72) Inventor: Anil Agiwal, McKinney, TX (US)

(21) Appl. No.: 19/093,087

(22) Filed: Mar. 27, 2025

Related U.S. Application Data
(60) Provisional application No. 63/635,010, filed on Apr. 17, 2024.

(51) Int. Cl. H04W 74/0833; H04W 48/14; H04W 72/02; H04W 72/0457

(52) U.S. Cl. CPC H04W 74/0833; H04W 48/14; H04W 72/02; H04W 72/0457

(57) ABSTRACT

A method of operating a UE includes receiving a message including at least one configuration for an initial UL BWP, selecting an initial UL BWP, and initiating an RA procedure for an SI request with N Msg1 repetitions on the selected initial UL BWP. The method also includes selecting an RA configuration, determining whether an SI request configuration for the SI request with N Msg1 repetitions includes a RACH occasions for SI IE, and if the SI request configuration for the SI request with N Msg1 repetitions does not include the RACH occasions for SI IE, applying a configuration of corresponding parameters expected in the RACH occasions for SI IE to determine RACH occasions for transmitting an SI request with N Msg1 repetitions on the selected initial UL BWP. The configuration of corresponding parameters is from a RACH common configuration IE of the selected RA configuration.

### CROSS-REFERENCE TO RELATED APPLICATION AND CLAIM OF PRIORITY

This application claims priority under 35 U.S.C. § 119(e) to U.S. Provisional Patent Application No. 63/635,010 filed on Apr. 17, 2024. The above-identified provisional patent application is hereby incorporated by reference in its entirety.

### TECHNICAL FIELD

This disclosure relates generally to wireless networks. More specifically, this disclosure relates to system information requests.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for system information requests.

In one embodiment, a user equipment (UE) is provided. The UE includes a transceiver configured to receive a message including at least one configuration for an initial uplink (UL) bandwidth part (BWP). The UE also includes a processor operably coupled to the transceiver. The processor is configured to select an initial UL BWP based on the at least one configuration for the initial UL BWP, and initiate a random access (RA) procedure for a system information (SI) request with N message 1 (Msg1) repetitions on the selected initial UL BWP. N is an integer greater than 1. The processor is also configured to select an RA configuration from at least one RA configuration for the UL BWP for the selected initial UL BWP upon initiation of the RA procedure, determine whether an SI request configuration for the SI request with N Msg1 repetitions includes a RA channel (RACH) occasions for SI information element (IE), and in response to a determination that the SI request configuration for the SI request with N Msg1 repetitions does not include the RACH occasions for SI IE, apply a configuration of corresponding parameters expected in the RACH occasions for SI IE to determine RACH occasions for transmitting an SI request with N Msg1 repetitions on the selected initial UL BWP. The configuration of corresponding parameters is from a RACH common configuration IE of the selected RA configuration.

In another embodiment, a method of operating a UE is provided. The method includes receiving a message including at least one configuration for a UL BWP, selecting an initial UL BWP based on the at least one configuration for the initial UL BWP, and initiating an RA procedure for an SI request with N Msg1 repetitions on the selected initial UL BWP. N is an integer greater than 1. The method also includes selecting an RA configuration from at least one RA configuration for the initial UL BWP for the selected initial UL BWP upon initiation of the RA procedure, determining whether an SI request configuration for the SI request with N Msg1 repetitions includes a RACH occasions for SI IE, and in response to a determination that the SI request configuration for the SI request with N Msg1 repetitions does not include the RACH occasions for SI IE, applying a configuration of corresponding parameters expected in the RACH occasions for SI IE to determine RACH occasions for transmitting an SI request with N Msg1 repetitions on the selected initial UL BWP. The configuration of corresponding parameters is from a RACH common configuration IE of the selected RA configuration.

In yet another embodiment, a non-transitory computer readable medium embodying a computer program is provided. The computer program includes program code that, when executed by a processor of a device, causes the device to receive a message including at least one configuration for a UL BWP, select an initial UL BWP based on the at least one configuration for the initial UL BWP, and initiate a RA procedure for an SI request with N Msg1 repetitions on the selected initial UL BWP. N is an integer greater than 1. The program code, when executed by the processor of the device, also causes the device to select an RA configuration from at least one RA configuration for the initial UL BWP for the selected initial UL BWP upon initiation of the RA procedure, determine whether an SI request configuration for the SI request with N Msg1 repetitions includes a RACH occasions for SI IE, and in response to a determination that the SI request configuration for the SI request with N Msg1 repetitions does not include the RACH occasions for SI IE, apply a configuration of corresponding parameters expected in the RACH occasions for SI IE to determine RACH occasions for transmitting an SI request with N Msg1 repetitions on the selected initial UL BWP. The configuration of corresponding parameters is from a RACH common configuration IE of the selected RA configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example process for a UE to perform an SI request with Msg1 repetitions according to embodiments of the present disclosure; and

FIG. 5 illustrates an example method for a system information request according to embodiments of the present disclosure.

### DETAILED DESCRIPTION

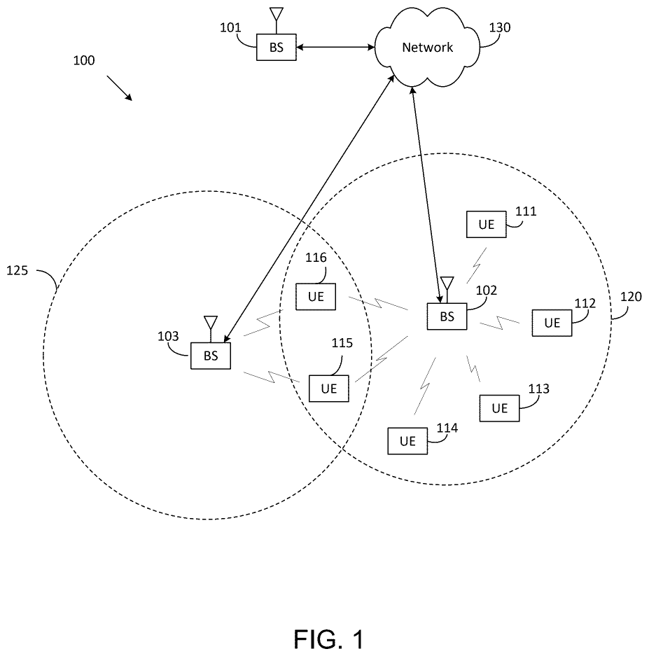

FIGS. 1 through 5, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for system information requests. In certain embodiments, one or more of the gNBs 101-103 includes circuitry, programing, or a combination thereof, to support system information requests in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

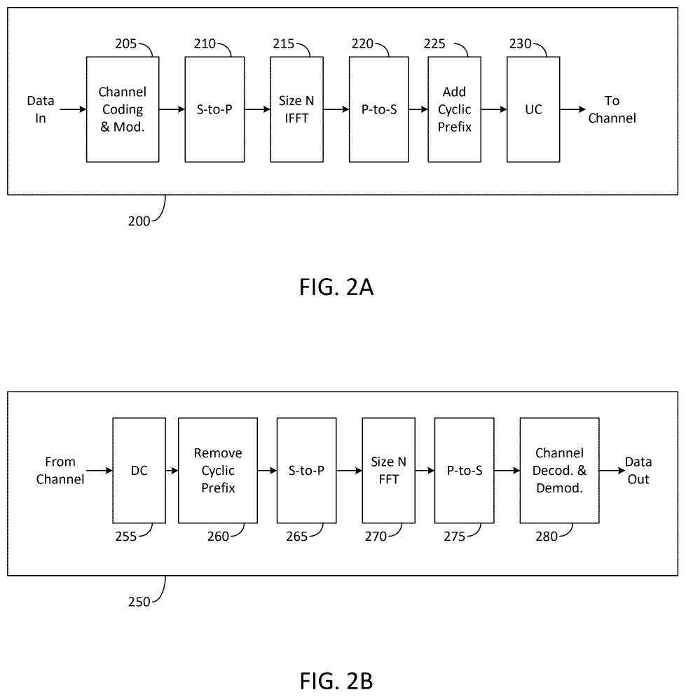

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support system information requests as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

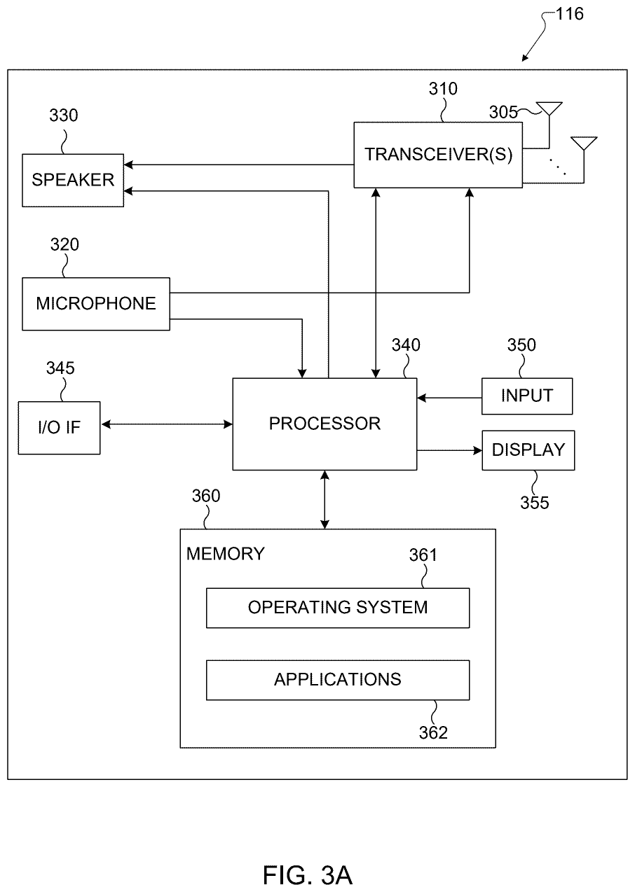

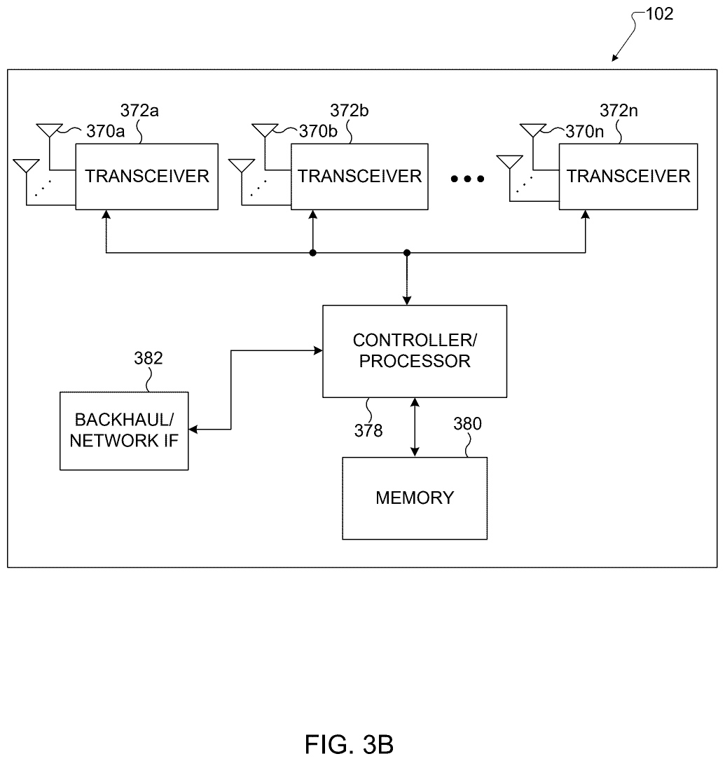

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for system information requests as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support system information requests as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell as each narrow TX beam provides coverage to a part of cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR PCell refers to a serving cell in a MCG, operating on the primary frequency, in which the UE either performs the initial connection establishment procedure or initiates the connection re-establishment procedure. In NR for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG, otherwise the term SpCell refers to the PCell.

In the next generation wireless communication system (e.g., 5G, beyond 5G, 6G), a next generation node B (gNB) or base station in cell broadcast Synchronization Signal and PBCH block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of system information blocks (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and positioning SIBs (posSIBs) are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get SFN timing of the SCG (which may be different from MCG). Upon a change of relevant SI for the SCell, the network releases and adds the concerned SCell. For the PSCell, the required SI can only be changed with Reconfiguration with Sync.

A UE acquires SIB1 from the camped or serving cell. The UE checks the BroadcastStatus bit in the SIB1 for an SI message which the UE acquires. An SI request configuration for San UL is signaled by the gNB using the IE si-RequestConfigSUL in SIB1. If the IE si-RequestConfigSUL is not present in SIB1, UE considers that the SI request configuration for the supplementary uplink (SUL) is not signaled by the gNB. The SI request configuration for the normal uplink (NUL) is signaled by the gNB using the IE si-RequestConfig in SIB1. If the IE si-RequestConfig is not present in the SIB1, the UE considers that the SI request configuration for the NUL is not signaled by the gNB. If the SI message which the UE needs to acquire is not being broadcast (i.e., a BroadcastStatus bit is set to zero), the UE initiates transmission of an SI request. The procedure for the SI request transmission is as follows:

If an SI request configuration is signaled by the gNB for the SUL, and criteria to select the SUL is met (i.e., RSRP derived from SSB measurements of the camped or serving cell<rsrp-ThresholdSSB-SUL, where rsrp-ThresholdSSB-SUL is signaled by the gNB [e.g., in broadcast signaling such as SIB1]), the UE initiates transmission of an SI request based on a message 1 (Msg1) based SI request on the SUL. In other words, the UE initiates a random access (RA) procedure using the PRACH preamble(s) and PRACH resource(s) in the SI request configuration of the SUL. The UE transmits a Msg1 (i.e., random access preamble) and waits for an acknowledgement for the SI request. Random access resources (PRACH preamble(s) and PRACH occasions(s)) indicated in the SI request configuration of the SUL are used for the Msg1. The Msg1 is transmitted on the SUL. If acknowledgement for the SI request is received, the UE monitors the SI window of the requested SI message in one or more SI period(s) of that SI message.

Otherwise, if the SI request configuration is signaled by the gNB for the NUL and criteria to select the NUL is met (i.e., the NUL is selected if the SUL is supported in the camped or serving cell and RSRP derived from SSB measurements of the camped or serving cell>=rsrp-ThresholdSSB-SUL, OR the NUL is selected if the SUL is not supported in serving cell), the UE initiates transmission of an SI request based on the Msg1 based SI request on the NUL. In other words, the UE initiates a random access procedure using the PRACH preamble(s) and PRACH resource(s) in the SI request configuration of the NUL. The UE transmits a Msg1 (i.e., Random access preamble) and waits for acknowledgement for the SI request. Random access resources (PRACH preamble(s) and PRACH occasions(s)) indicated in SI request configuration of the NUL is used for Msg1. Msg1 is transmitted on the NUL. If an acknowledgement for the SI request is received, the UE monitors the SI window of the requested SI message in one or more SI period(s) of that SI message.

Otherwise, if the UE initiates transmission of the SI request based on a message 3 (Msg3) based SI request. In other words, the UE initiates transmission of a RRCSystemInfoRequest message. The UE transmits a Msg1 (i.e., Random access preamble) and waits for a random access response. Common random access resources (PRACH preamble(s) and PRACH occasions(s)) are used for the Msg1. In the UL grant received in a random access response, the UE transmits an RRCSystemInfoRequest message and waits for acknowledgement for the SI request (i.e., RRCSystemInfoRequest message). If an acknowledgement for the SI request (i.e., RRCSystemInfoRequest message) is received, the UE monitors the SI window of the requested SI message in one or more SI period(s) of that SI message. Note that if the SUL is configured, the UL carrier for Msg1 transmission will be selected by the UE in a similar manner as selected by the UE for a Msg1 based SI request. The SUL is the selected UL carrier if RSRP derived from SSB measurements of the camped or serving cell<rsrp-ThresholdSSB-SUL where rsrp-ThresholdSSB-SUL is signaled by the gNB (e.g., in broadcast signaling such as SIB1). The NUL is the selected UL carrier if RSRP derived from SSB measurements of the camped or serving cell>=rsrp-ThresholdSSB-SUL where rsrp-ThresholdSSB-SUL is signaled by the gNB (e.g., in broadcast signaling such as SIB1).

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel) PUSCH, where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G) a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL RS ID (SSB or CSI RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured). In the RRC IDLE and RRC INACTIVE states, the UE transmits/receives to/from the gNB on the initial Uplink BWP and initial DL BWP respectively. For a reduced capacity (RedCap) UE, the initial Uplink BWP and initial DL BWP for the RedCap UE can be optionally configured, which is used by RedCap UE, if configured.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in RRC CONNECTED state. Several types of RA procedures are supported.

In contention based random access (CBRA), also referred to as 4 step CBRA, the UE first transmits a random access preamble (also referred to as a Msg1) and then waits for a random access response (RAR) in the RAR window. The RAR is also referred to as a Msg2. The gNB transmits the RAR on a PDSCH. A PDCCH scheduling the PDSCH carrying the RAR is addressed to an RA-radio network temporary identifier (RA-RNTI). The RA-RNTI identifies the time-frequency resource (also referred to as a physical RA channel [PRACH] occasion or PRACH TX occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for the NUL carrier and 1 for the SUL carrier). Several RARs for various Random-access preambles detected by the gNB can be multiplexed in the same RAR media access control (MAC) protocol data unit (PDU) by gNB. A RAR in a MAC PDU corresponds to the UE's RA preamble transmission if the RAR includes an RA preamble identifier (RAPID) of RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step (i.e., the LIE selects a random access resource [preamble/RACH occasion] and transmits the RA preamble). A backoff may be applied before going back to first step.

If the RAR corresponding to the UE's RA preamble transmission is received the LIE transmits a Msg3 in the UL grant received in the RAR. The Msg3 includes a message such as an RRC connection request, RRC connection re-establishment request, RRC handover confirm, scheduling request, SI request etc. The Msg3 may include the IE identity (i.e., cell-radio network temporary identifier [C-RNTI] or system architecture evolution [SAE]-temporary mobile subscriber identity [S-TMSI] or a random number). After transmitting the Msg3, The UE starts a contention resolution timer. While the contention resolution timer is running, if the LIE receives a PDCCH addressed to the C-RNTI included in the Msg3, contention resolution is considered successful, the contention resolution timer is stopped, and the RA procedure is completed. While the contention resolution timer is running, if the LIE receives a contention resolution MAC control element (CE) including the UE's contention resolution identity (the first X bits of a common control channel [CCCH] service data unit [SDU] transmitted in the Msg3), contention resolution is considered successful, the contention resolution timer is stopped, and the RA procedure is completed. If the contention resolution timer expires and the LIE has not yet transmitted the RA preamble for a configurable number of times, the UE goes back to the first step (i.e., the LIE selects a random access resource [preamble/RACH occasion] and transmits the RA preamble). A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An Evolved node B (eNB) assigns to the LIE a dedicated random access preamble. The LIE transmits the dedicated RA preamble. The eNB transmits the RAR on a PDSCH addressed to an RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such has handover and beam failure recovery if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there are no SSB/CSI RS having a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. During the RA procedure, one random access attempt can be CFRA while other random access attempts can be CBRA.

For 2 step contention based random access (2 step CBRA), in the first step, the UE transmits a random access preamble on a PRACH and a payload (i.e., MAC PDU) on a PUSCH. The random access preamble and payload transmission is also referred to as a message A (MsgA). In the second step, after the MsgA transmission, the UE monitors for a response from the network (i.e., a gNB) within a configured window. The response is also referred to as a message B (MsgB). A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where UE has transmitted the MsgA (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier).

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting the Msg3), the UE retransmits the MsgA. If the configured window in which the UE monitors for a network response after transmitting the MsgA expires and the UE has not received a MsgB including contention resolution information or fallback information as explained above, the UE retransmits MsgA. If the random access procedure is not successfully completed even after transmitting the MsgA configurable number of times, the UE falls back to the 4 step RACH procedure (i.e., the UE only transmits the PRACH preamble).

A MsgA payload may include one or more of a CCCH SDU, dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., a random ID, S-TMSI, C-RNTI, resume ID, etc.) along with a preamble in the first step. The UE ID may be included in the MAC PDU of the MsgA. AUE ID such as a C-RNTI may be carried in the MAC CE, wherein the MAC CE is included in The MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before the UE is attached to the network), then the UE ID is the random ID. When the UE performs an RA in an IDLE state after the UE is attached to network, the UE ID is an S-TMSI. If the UE has an assigned C-RNTI (e.g., in a connected state), the UE ID is the C-RNTI. In case the UE is in an INACTIVE state, the UE ID is a resume ID. In addition to the UE ID, some addition control information can be sent in a MsgA. The control information may be included in the MAC PDU of the MsgA. The control information may include one or more of a connection request indication, connection resume request indication, SI request indication, buffer status indication, beam information (e.g., one or more DL TX beam ID[s] or SSB ID[s]), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE dedicated random access preamble(s) and PUSCH resource(s) for MsgA transmission. RACH occasions (ROs) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for an NUL carrier and 1 for an SUL carrier).

If the UE receives a PDCCH addressed to the C-RNTI, the random access procedure is considered successfully completed. If the UE receives fallback information corresponding to its transmitted preamble, the random access procedure is considered successfully completed.

For certain events such has handover and beam failure recovery if dedicated preamble(s) and PUSCH resource(s) are assigned to the UE, during first step of random access (i.e., during random access resource selection for MsgA transmission) the UE determines whether to transmit a dedicated preamble or a non-dedicated preamble. Dedicated preambles are typically provided for a subset of SSBs/CSI RSs. If there is no SSB/CSI RS having a DL RSRP above a threshold amongst the SSBs/CSI RSs for which contention free random access resources (i.e., dedicated preambles/ROs/PUSCH resources) are provided by the gNB, the UE selects a non-dedicated preamble. Otherwise, the UE selects a dedicated preamble. During the RA procedure, one random access attempt can be 2 step CFRA while other random access attempts can be 2 step CBRA.

Upon initiation of a random access procedure, the UE first selects the uplink carrier (SUL or NUL). If the carrier to use for the random-access procedure is explicitly signaled by the gNB, the UE selects the signaled carrier for performing the random-access procedure. If (i) the carrier to use for the random access procedure is not explicitly signaled by the gNB, and (ii) if the serving cell for the random access procedure is configured with supplementary uplink, and (iii) if the RSRP of the downlink pathloss reference is less than rsrp-ThresholdSSB-SUL, the UE selects the SUL carrier for performing the random access procedure. Otherwise, the UE selects the NUL carrier for performing the random-access procedure. Upon selecting the UL carrier, the UE determines the UL and DL BWP for the random access procedure. The UE then determines whether to perform 2 step or 4 step RACH for this random access procedure as follows:

If (i) this random access procedure is initiated by a PDCCH order, and (ii) if the ra-PreambleIndex explicitly provided by the PDCCH is not 0b000000, the UE selects 4 step RACH. Otherwise, if 2 step contention free random access resources are signaled by the gNB for this random access procedure, the UE selects 2 step RACH. Otherwise, if 4 step contention free random access resources are signaled by the gNB for this random access procedure, the UE selects 4 step RACH. Otherwise, if the UL BWP selected for this random access procedure is configured with only 2 step RACH resources, the UE selects 2 step RACH. Otherwise, if the UL BWP selected for this random access procedure is configured with only 4 step RACH resources, the UE selects 4 step RACH. Otherwise, if the UL BWP selected for this random access procedure is configured with both 2 step and 4 step RACH resources, if the RSRP of the downlink pathloss reference is below a configured threshold, the UE selects 4 step RACH. Otherwise, the UE selects 2 step RACH.

In the next generation wireless communication system (e.g., 5G, beyond 5G, 6G), UEs with reduced capabilities are supported.

A RedCap UE refers to a UE with the following reduced capability:
The maximum bandwidth is 20 MHz for FR1 (i.e., frequency range of 410 MHz-7125 MHz), and is 100 MHz for FR2 (i.e., frequency range of 24250 MHz-52600 MHz). UE features and corresponding capabilities related to UE bandwidths wider than 20 MHz in FR1 or wider than 100 MHz in FR2 are not supported by RedCap UEs;
The maximum mandatory supported data radio bearer (DRB) number is 8;
The mandatory supported packet data convergence protocol (PDCP) sequence number (SN) length is 12 bits, with a PDCP SN length of 18 bits being optional;
The mandatory supported radio link control (RLC) acknowledge mode (AM) SN length is 12 bits, with an RLC AM SN length of 18 bits being optional;
For FR1, 1 DL MIMO layer if 1 Rx branch is supported, and 2 DL MIMO layers if 2 Rx branches are supported; for FR2, either 1 or 2 DL MIMO layers can be supported, while 2 Rx branches are always supported. For FR1 and FR2, UE features and corresponding capabilities related to more than 2 UE Rx branches or more than 2 DL MIMO layers, as well as UE features and capabilities related to more than 1 UE Tx branch, or more than 1 UL MIMO layer are not supported by RedCap UEs;
CA, MR-DC, DAPS, CPAC and IAB (i.e., the RedCap UE is not expected to act as IAB node) related UE features and corresponding capabilities are not supported by RedCap UEs. All other feature groups or components of the feature groups as well as capabilities specified in this specification remain applicable for RedCap UEs the same as non-RedCap UEs, unless indicated otherwise.

An enhanced RedCap (eRedCap) UE refers to a UE with one or more of the following reduced capabilities in addition to the reduced capabilities defined above for a RedCap UE:
UE baseband (BB) bandwidth reduction;
   5 MHz BB bandwidth only for PDSCH (for both unicast and broadcast) and PUSCH, with 20 MHz RF bandwidth for UL and DL;
   The other physical channels and signals are still allowed to use a BWP up to the 20 MHz maximum UE RF+BB bandwidth.
UE peak data rate reduction.

In the next generation wireless communication system (e.g., 5G, beyond 5G, 6G), for UL coverage enhancements, repetitions of PRACH transmissions within a single random access attempt (or PRACH attempt) is considered. For multiple PRACH transmissions within one RACH attempt, PRACH transmissions are only transmitted over ROs associated with the same SSB/CSI-RS. For multiple PRACH transmissions with same Tx beam in one RACH attempt, transmission power ramping is not applied within one RACH attempt. For multiple PRACH transmissions with the same Tx beam, only one RAR window is supported for RAR monitoring for one RACH attempt. For multiple PRACH transmissions with the same Tx beam, to differentiate the multiple PRACH transmissions from a single PRACH transmission, the multiple PRACH transmissions being transmitted on separate ROs is supported. For multiple PRACH transmissions with same Tx beam, to differentiate the multiple PRACH transmissions from a single PRACH transmission, the multiple PRACH transmissions being transmitted with separate preambles on shared ROs is supported. For multiple PRACH transmissions with the same Tx beam, the gNB can configure one or multiple values for the number of multiple PRACH transmissions. If multiple values are configured, PRACH resources differentiation between multiple PRACH transmissions with a different number of multiple PRACH transmissions is supported.

In the next generation wireless communication system (e.g., 5G, beyond 5G, 6G), a UE in an RRC IDLE/RRC_INACTIVE state may be camped on a cell. The Cell may be configured with an initial uplink BWP (configured by a field initialUplinkBWP) for a NUL in SIB1 and/or an initial uplink BWP (configured by a field initialUplinkBWP) for a SUL in SIB1 and/or a RedCap specific initial uplink BWP (configured by a field initialUplinkBWP-Redcap) for the NUL in SIB1. Each of these BWPs can be configured with one or more random access resource configurations or sets of random access resources. The random access resource configuration or a set of random access resources can be associated with a feature or combination of features or no feature. For example, the feature can be one of SDT, Msg1 repetition, slicing, Msg3 repetitions, redcap etc. The random access resource configuration includes (at least) a RACH common configuration IE (RACH-ConfigCommon). RACH-ConfigCommon may be similar as shown below:

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |
| } | OPTIONAL, -- Need M |
| groupBconfigured | SEQUENCE { |
| ra-Msg3SizeGroupA | ENUMERATED {b56, b144, b208, b256, b282, b480, |

b640,

b800, b1000, b72, spare6, spare5, spare4, spare3, spare2,

spare1},

| | |
|---|---|
| messagePowerOffsetGroupB | ENUMERATED { minusinfinity, dB0, dB5, dB8, |

dB10, dB12, dB15, dB18},

| | |
|---|---|
| numberOfRA-PreamblesGroupA | INTEGER (1..64) |
| } | OPTIONAL, -- Need R |
| ra-ContentionResolutionTimer | ENUMERATED { sf8, sf16, sf24, sf32, sf40, sf48, sf56, |

sf64},

| | | |
|---|---|---|
| rsrp-ThresholdSSB | RSRP-Range | OPTIONAL, |

-- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |
| 1839 | INTEGER (0..837), |
| 1139 | INTEGER (0..137) |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} |

```
OPTIONAL, -- Need R
  ...,
  [[
  ra-PrioritizationForAccessIdentity-r16 SEQUENCE {
```

| | |
|---|---|
| ra-Prioritization-r16 | RA-Prioritization, |
| ra-PrioritizationForAI-r16 | BIT STRING (SIZE (2)) |
| } | OPTIONAL, -- Cond |

InitialBWP-Only

| | |
|---|---|
| prach-RootSequenceIndex-r16 | CHOICE { |
| 1571 | INTEGER (0..569), |
| 11151 | INTEGER (0..1149) |

```
  } OPTIONAL  -- Need R
  ]],
  [[
```

| | |
|---|---|
| ra-PrioritizationForSlicing-r17 | RA-PrioritizationForSlicing-r17 |

OPTIONAL, -- Cond InitialBWP-Only

| | |
|---|---|
| featureCombinationPreamblesList-r17 | SEQUENCE |

(SIZE(1..maxFeatureCombPreamblesPerRACHResource-r17)) OF
FeatureCombinationPreambles-r17 OPTIONAL -- Cond AdditionalRACH
]]
}

A UE as described above can be a (e)RedCap UE or a non (e)rRedCap UE. A non RedCap UE is a UE which is neither a RedCap UE nor an eRedCap UE.

An SI request configuration for Msg1 repetition may be configured for the initial uplink BWP on the NUL in SIB1. An SI request configuration for Msg1 repetition may be configured for the initial uplink BWP on the SUL in SIB1. An SI request configuration for Msg1 repetition may be configured for the RedCap specific initial uplink BWP on the NUL in SIB1. The SI request configuration for Msg1 repetition may include SI request resources for 2 and/or 4 and/or 8 repetitions.

The SI request configuration for Msg1 repetition may include a rach-OccasionsSI IE. The rach-OccasionsSI IE may be defined as follows:

| | |
|---|---|
| rach-OccasionsSI-r18 | SEQUENCE { |
| rach-ConfigSI-r18 | RACH-ConfigGeneric, |
| ssb-perRACH-Occasion-r18 | ENUMERATED {oneEighth, oneFourth, oneHalf, |

```
    one, two, four, eight, sixteen}
  }
```

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED |
| {scf1,scf2,scf4,scf8,scf16,scf32,scf64} | OPTIONAL, -- Need R |
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { s160, sl160} |

OPTIONAL, -- Need R

| | |
|---|---|
| prach-ConfigurationIndex-v1610 | INTEGER (256..262) |

```
OPTIONAL -- Need R
  ]],
  [[
```

| | |
|---|---|
| ra-ResponseWindow-v1700 | ENUMERATED {sl240, sl320, sl640, sl960, sl1280, |
| sl1920, sl2560} OPTIONAL | -- Need R |

]]
}

For an SI request with Msg1 repetition on a BWP (the BWP can be the initial uplink BWP on the SUL or the initial uplink BWP on the NUL or the RedCap specific initial uplink BWP), the UE applies the configuration in rach-OccasionsSI IE included in “SI request configuration for Msg1 repetition” in that BWP to determine RACH occasions for transmitting the SI request. However, which configuration of the BWP is applied when a rach-OccasionsSI IE is not included in the SI request configuration for Msg1 repetition is undefined. To overcome this issue, various embodiments of the present disclosure provide a mechanism for a UE to determine which configuration of a BWP to apply when a rach-OccasionsSI IE is not included in an SI request configuration for Msg1 repetition.

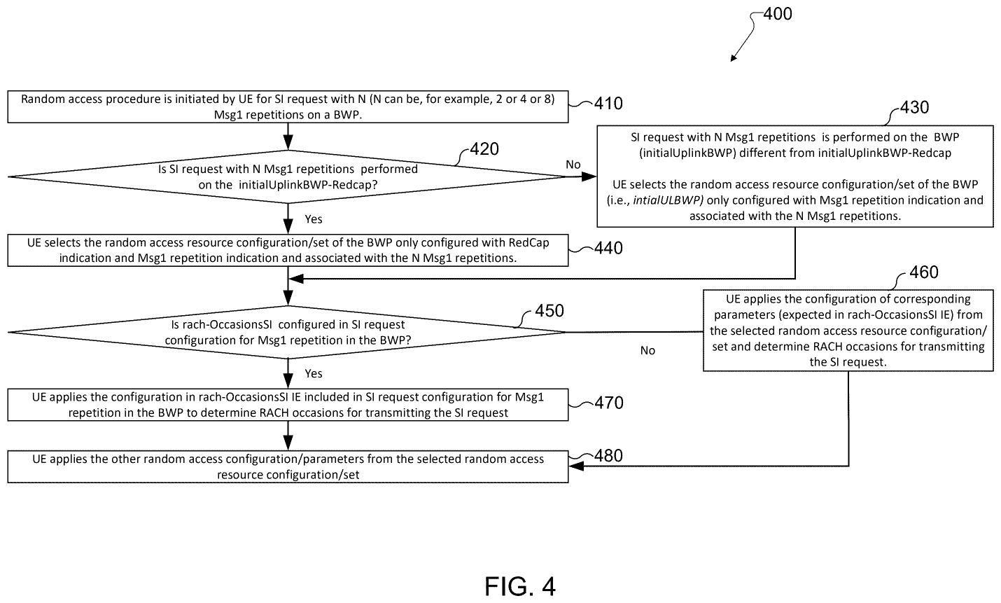

FIG. 4 illustrates an example process 400 for a UE to perform an SI request with Msg1 repetitions according to embodiments of the present disclosure. An embodiment of the process illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a process for a UE to perform an SI request with Msg1 repetitions could be used without departing from the scope of this disclosure.

In the example of FIG. 4, process 400 is performed by a UE (such as UE 116 of FIG. 1) that is in an RRC IDLE/RRC_INACTIVE state. The UE is camped on a cell. The cell may be configured with an initial uplink BWP (configured by a field initialUplinkBWP) on a NUL in SIB1, an initial uplink BWP (configured by a field initialUplinkBWP) for an SUL in SIB1, and a RedCap specific initial uplink BWP (configured by a field initialUplinkBWP-Redcap) for the NUL in SIB1. Each of these BWPs can be configured with one or more random access resource configurations. In some embodiments, the random access resource configuration can be associated with a feature or combination of features or no feature. In some embodiments, the feature can be one of small data transmission (SDT), Msg1 repetition, slicing, Msg3 repetition, RedCap, etc. The random access resource configuration includes, at least, a RACH common configuration (RACH-ConfigCommon) IE.

In some embodiments, the UE can be a (e)RedCap UE or a non (e)RedCap UE. A non RedCap UE is a UE which is neither a RedCap UE nor an eRedCap UE.

In some embodiments, an SI request configuration for Msg1 repetition may be configured for an initial uplink BWP on the NUL in SIB1. In some embodiments, an SI request configuration for Msg1 repetition may be configured for an initial uplink BWP on the SUL in SIB1. In some embodiments, an SI request configuration for Msg1 repetition may be configured for a RedCap specific initial uplink BWP on the NUL in SIB1. In some embodiments, an SI request configuration for Msg1 repetition may include SI request resources for 2 and/or 4 and/or 8 repetitions.

In some embodiments, an SI request configuration for Msg1 repetition may include a rach-OccasionsSI IE.

In the example of FIG. 4, process 400 begins at operation 410. At operation 410, the UE initiates an RA procedure for an SI request with N Msg1 repetitions on a BWP. For example, in some embodiments N can be 2 or 4 or 8. The BWP is one of an initial uplink BWP on a SUL, an initial uplink BWP on a NUL, and a RedCap specific initial uplink BWP on the NUL.

At operation 420, the UE determines whether the SI request with N Msg1 repetitions is to be performed on the RedCap specific initial uplink BWP on the NUL (initialUplinkBWP-Redcap). If the SI request with N Msg1 repetitions is performed on the initialUplinkBWP-Redcap, or if the UE is a (e)RedCap UE and the SI request with N Msg1 repetitions is performed on the initialUplinkBWP-Redcap, the method proceeds to operation 440. Otherwise, (e.g., the SI request with N Msg1 repetitions is performed on the initialUplinkBWP on the SUL or initialUplinkBWP on the NUL) the method proceeds to operation 430.

At operation 430, the UE selects a random access resource configuration/set of the BWP (i.e., intialUplinkBWP), wherein the selected random access resource configuration/set is only configured with a Msg1 repetition indication and associated with the N Msg1 repetitions.

At operation 440, the UE selects a random access resource configuration/set of the BWP (i.e., initialUplinkBWP-Redcap), wherein the selected random access resource configuration/set is only configured with a RedCap indication and a Msg1 repetition indication and associated with the N Msg1 repetitions.

At step 450, the UE determines whether a rach-OccasionsSI IE is configured in an SI request configuration for Msg1 repetition in the BWP. If a rach-OccasionsSI IE is configured in the SI request configuration for Msg1 repetition in the BWP, process 400 proceeds to operation 470. Otherwise, process 400 proceeds to operation 460.

At operation 460, the UE applies the configuration of corresponding parameters (expected in the rach-OccasionsSI IE) from the selected random access resource configuration/set and determines RACH occasions for transmitting the SI request. the UE may apply the configuration of the RACH-ConfigGeneric IE and ssb-perRACH-Occasion from RACH-ConfigCommon IE of the selected random access resource configuration/set.

At operation 470, the UE applies the configuration in the rach-OccasionsSIIE included in the SI request configuration for Msg1 repetition in the BWP to determine RACH occasions for transmitting the SI request. For example, the UE may apply the configuration of the RACH-ConfigGeneric IE and ssb-perRACH-Occasion from the rach-OccasionsSI IE.

At operation 480, the UE applies the other random access configuration/parameters (i.e., other than those included in the rach-OccasionsSI IE) from the selected random access resource configuration/set (e.g. from the RACH-ConfigCommon IE of the selected random access resource configuration/set), and transmits the SI request in one of the RACH occasions.

Although FIG. 4 illustrates one example process 400 for a UE to perform an SI request with Msg1 repetitions, various changes may be made to FIG. 4. For example, while shown as a series of operations, various operations in FIG. 4 could overlap, occur in parallel, occur in a different order, occur any number of times, be omitted, or replaced by other steps.

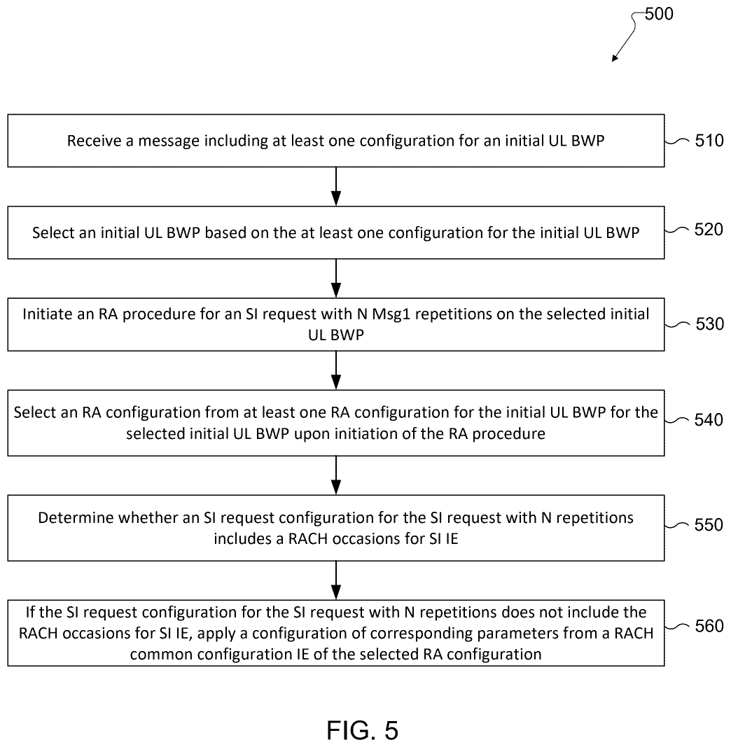

FIG. 5 illustrates an example method 500 for a system information request according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for a system information request could be used without departing from the scope of this disclosure.

In the example of FIG. 5, method 500 begins at step 510. At step 510, a UE (such as UE 116 of FIG. 1) receives (e.g., from a BS such as gNB 102 of FIG. 1) a message including at least one configuration for an initial UL BWP.

At step 520, the UE selects an initial UL BWP based on the at least one configuration for the initial UL BWP.

At step 530, the UE initiates an RA procedure for an SI request with N Msg1 repetitions on the selected initial UL BWP. N is an integer greater than 1.

At step 540, the UE selects an RA configuration from at least one RA configuration for the initial UL BWP for the selected initial UL BWP upon initiation of the RA procedure.

At step 550, the UE determines whether an SI request configuration for the SI request with N Msg1 repetitions includes a RACH occasions for SI IE.

At step 560, in response to a determination that the SI request configuration for the SI request with N Msg1 repetitions does not include the RACH occasions for SI IE, the UE applies a configuration of corresponding parameters expected in the RACH occasions for SI IE to determine RACH occasions for transmitting an SI request with N Msg1 repetitions on the selected initial UL BWP. For example, the configuration of corresponding parameters can be from a RACH common configuration IE of the selected RA configuration.

In some embodiments, in response to a determination that the SI request configuration for the SI request with N Msg1 repetitions includes the RACH occasions for SI IE, the UE may apply a configuration in the RACH occasions for SI IE to determine RACH occasions for transmitting the SI request on the selected initial UL BWP.

In some embodiments, the UE may apply RA configuration parameters not configured in a RACH occasions for SI IE from the selected RA configuration.

In some embodiments, the at least one configuration for the initial UL BWP may include a configuration for at least one of an initial uplink BWP on a NUL, an initial uplink BWP on an SUL, and a RedCap specific initial uplink BWP on a NUL.

In some embodiments, the UE may be a RedCap UE. In some embodiments, the UE is may be an eRedCap UE.

In some embodiments, the UE may determine whether the SI request with N Msg1 repetitions is to be performed on a RedCap specific initial UL BWP. When the determination is that the SI request with N Msg1 repetitions is to be performed on the RedCap specific initial UL BWP, the selected RA configuration may be an RA configuration only configured with a RedCap indication and a Msg1 repetition indication and associated with the N Msg1 repetitions. When the determination is that the SI request with N Msg1 repetitions is not to be performed on the RedCap specific initial UL BWP, the selected RA configuration may be an RA configuration only configured with a Msg1 repetition indication and associated with the N Msg1 repetitions.

Although FIG. 5 illustrates one example method 500 for a system information request, various changes may be made to FIG. 5. For example, while shown as a series of steps, various steps in FIG. 5 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive a message including at least one configuration for an initial uplink (UL) bandwidth part (BWP); and
a processor operably coupled to the transceiver, the processor configured to:
select an initial UL BWP based on the at least one configuration for the initial UL BWP;
initiate a random access (RA) procedure for a system information (SI) request with N message 1 (Msg1) repetitions on the selected initial UL BWP, wherein N is an integer greater than 1;
select an RA configuration from at least one RA configuration for the UL BWP for the selected initial UL BWP upon initiation of the RA procedure;
determine whether an SI request configuration for the SI request with N Msg1 repetitions includes a RA channel (RACH) occasions for SI information element (IE); and
in response to a determination that the SI request configuration for the SI request with N Msg1 repetitions does not include the RACH occasions for SI IE, apply a configuration of corresponding parameters expected in the RACH occasions for SI IE to determine RACH occasions for transmitting an SI request with N Msg1 repetitions on the selected initial UL BWP, wherein the configuration of corresponding parameters is from a RACH common configuration IE of the selected RA configuration.

2. The UE of claim 1, wherein the processor is further configured to, in response to a determination that the SI request configuration for the SI request with N Msg1 repetitions includes the RACH occasions for SI IE, apply a configuration in the RACH occasions for SI IE to determine RACH occasions for transmitting the SI request on the selected initial UL BWP.

3. The UE of claim 1, wherein the processor is further configured to:
determine whether the SI request with N Msg1 repetitions is to be performed on a reduced capacity (RedCap) specific initial UL BWP,
wherein, when the determination is that the SI request with N Msg1 repetitions is to be performed on the RedCap specific initial UL BWP, the selected RA configuration is an RA configuration only configured with a RedCap indication and a Msg1 repetition indication and associated with the N Msg1 repetitions.

4. The UE of claim 3, wherein, when the determination is that the SI request with N Msg1 repetitions is not to be performed on the RedCap specific initial UL BWP, the selected RA configuration is an RA configuration only configured with a Msg1 repetition indication and associated with the N Msg1 repetitions.

5. The UE of claim 3 wherein the UE is a RedCap UE or enhanced RedCap (eRedCap) UE.

6. The UE of claim 1, wherein the processor is further configured to apply RA configuration parameters not configured in a RACH occasions for SI IE from the selected RA configuration.

7. The UE of claim 1, wherein the at least one configuration for the initial UL BWP includes a configuration for at least one of:
an initial uplink BWP on a normal uplink (NUL);
an initial uplink BWP on a supplementary uplink (SUL); and
a RedCap specific initial uplink BWP on a normal uplink (NUL).

8. A method of operating a user equipment (UE), the method comprising:
receiving a message including at least one configuration for an initial uplink (UL) bandwidth part (BWP);
selecting an initial UL BWP based on the at least one configuration for the initial UL BWP;
initiating a random access (RA) procedure for a system information (SI) request with N message 1 (Msg1) repetitions on the selected initial UL BWP, wherein N is an integer greater than 1;
selecting an RA configuration from at least one configuration for the initial UL BWP for the selected initial UL BWP upon initiation of the RA procedure;
determining whether an SI request configuration for the SI request with N Msg1 repetitions includes a RA channel (RACH) occasions for SI information element (IE); and
in response to a determination that the SI request configuration for the SI request with N Msg1 repetitions does not include the RACH occasions for SI IE, applying a configuration of corresponding parameters expected in the RACH occasions for SI IE to determine RACH occasions for transmitting an SI request with N Msg1 repetitions on the selected initial UL BWP, wherein the configuration of corresponding parameters is from a RACH common configuration IE of the selected RA configuration.

9. The method of claim 8, further comprising, in response to a determination that the SI request configuration for the SI request with N Msg1 repetitions includes the RACH occasions for SI IE, applying a configuration in the RACH occasions for SI IE to determine RACH occasions for transmitting the SI request on the selected initial UL BWP.

10. The method of claim 8, further comprising determining whether the SI request with N Msg1 repetitions is to be performed on a reduced capacity (RedCap) specific initial UL BWP,
wherein, when the determination is that the SI request with N Msg1 repetitions is to be performed on the RedCap specific initial UL BWP, the selected RA configuration is an RA configuration only configured with a RedCap indication and a Msg1 repetition indication and associated with the N Msg1 repetitions.

11. The method of claim 10, wherein, when the determination is that the SI request with N Msg1 repetitions is not to be performed on the RedCap specific initial UL BWP, the selected RA configuration is an RA configuration only configured with a Msg1 repetition indication and associated with the N Msg1 repetitions.

12. The method of claim 10 wherein the UE is a RedCap UE or enhanced RedCap (eRedCap) UE.

13. The method of claim 8, further comprising applying RA configuration parameters not configured in a RACH occasions for SI IE from the selected RA configuration.

14. The method of claim 8, wherein the at least one configuration for the initial UL BWP includes a configuration for at least one of:
an initial uplink BWP on a normal uplink (NUL);
an initial uplink BWP on a supplementary uplink (SUL); and
a RedCap specific initial uplink BWP on a NUL.

15. A non-transitory computer readable medium embodying a computer program comprising program code that, when executed by a processor of a device, causes the device to:
receive a message including at least one configuration for an initial uplink (UL) bandwidth part (BWP);
select an initial UL BWP based on the at least one configuration for the initial UL BWP;
initiate a random access (RA) procedure for a system information (SI) request with N message 1 (Msg1) repetitions on the selected initial UL BWP, wherein N is an integer greater than 1;
select an RA configuration from at least one RA configuration for the initial UL BWP for the selected initial UL BWP upon initiation of the RA procedure;
determine whether an SI request configuration for the SI request with N Msg1 repetitions includes a RA channel (RACH) occasions for SI information element (IE); and
in response to a determination that the SI request configuration for the SI request with N Msg1 repetitions does not include the RACH occasions for SI IE, apply a configuration of corresponding parameters expected in the RACH occasions for SI IE to determine RACH occasions for transmitting an SI request with N Msg1 repetitions on the selected initial UL BWP, wherein the configuration of corresponding parameters is from a RACH common configuration IE of the selected RA configuration.

16. The non-transitory computer readable medium of claim 15, wherein the computer program comprises program code that, when executed by the processor of the device, causes the device to, in response to a determination that the SI request configuration for the SI request with N Msg1 repetitions includes the RACH occasions for SI IE, apply a configuration in the RACH occasions for SI IE to determine RACH occasions for transmitting the SI request on the selected initial UL BWP.

17. The non-transitory computer readable medium of claim 15, wherein:
the computer program comprises program code that, when executed by the processor of the device, causes the device to determine whether the SI request with N Msg1 repetitions is to be performed on a reduced capacity (RedCap) specific initial UL BWP; and
when the determination is that the SI request with N Msg1 repetitions is to be performed on the RedCap specific initial UL BWP, the selected RA configuration is an RA configuration only configured with a RedCap indication and a Msg1 repetition indication and associated with the N Msg1 repetitions.

18. The non-transitory computer readable medium of claim 17, wherein, when the determination is that the SI request with N Msg1 repetitions is not to be performed on the RedCap specific initial UL BWP, the selected RA configuration is an RA configuration only configured with a Msg1 repetition indication and associated with the N Msg1 repetitions.

19. The non-transitory computer readable medium of claim 15, wherein the computer program comprises program code that, when executed by the processor of the device, causes the device to apply RA configuration parameters not configured in a RACH occasions for SI IE from the selected RA configuration.

20. The non-transitory computer readable medium of claim 15, wherein the at least one configuration for the initial UL BWP includes a configuration for at least one of:
an initial uplink BWP on a normal uplink (NUL);
an initial uplink BWP on a supplementary uplink (SUL); and
a RedCap specific initial uplink BWP on a NUL.
